(19) United States
(12) Patent Application Publication
(10) Pub. No.: US 2015/0088953 A1
(43) Pub. Date: Mar. 26, 2015

(54) METHODS, SYSTEMS AND COMPUTER-READABLE MEDIA FOR DISTRIBUTED PROBABILISTIC MATRIX FACTORIZATION

(71) Applicant: Infosys Limited, Bangalore (IN)

(72) Inventors: Hari Manassery Koduvely, BANGALORE (IN); Sarbendu Guha, BANGALORE (IN); Arun Yadav, BANGALORE (IN); David C. Gladbin, THRISSUR(DT) (IN); Naveen Chandra Tewari, MORADABAD (IN); Utkarsh Gupta, GWALIOR (IN)

(21) Appl. No.: 14/493,308

(22) Filed: Sep. 22, 2014

(30) Foreign Application Priority Data
Sep. 23, 2013 (IN) 4292/CHE/2013

(51) Int. Cl. G06F 17/16; G06F 17/18

(52) U.S. Cl. CPC G06F 17/16; G06F 17/18
USPC 708/520

(57) ABSTRACT

The present invention provides a method and system for distributed probabilistic matrix factorization. In accordance with a disclosed embodiment, the method may include partitioning a sparse matrix into a first set of blocks on a distributed computer cluster, whereby a dimension of each block is MB rows and NB columns. Further, the method shall include initializing a plurality of matrices including first mean matrix Ū, a first variance matrix Ũ, a first prior variance matrix Ũ^{P}, a second mean matrix V̅, a second variance matrix \tilde{V}, and a second prior variance matrix \tilde{V}^{P}, by a set of values from a probability distribution function. The plurality of matrices can be partitioned into a set of blocks on the distributed computer cluster, whereby each block can be of a shorter dimension K, and the plurality of matrices can be updated iteratively until a cost function of the sparse matrix converges.

### RELATED APPLICATION DATA

This application claims priority to India Patent Application No. 4292/CHE/2013, filed Sep. 23, 2013, the disclosure of which is hereby incorporated by reference in its entirety.

### FIELD OF THE INVENTION

The present invention relates generally to a method and system for distributed collaborative filtering. More specifically, the present invention relates to a method and system for probabilistic matrix factorization in a distributed computing cluster

### BACKGROUND

In an e-commerce scenario, collaborative filtering is a commonly used technology for recommending products to users. In collaborative filtering similarity between products or similarity between users can be found by ratings given to the products by the users. Hence, a product which is not purchased by a user may be recommended to the user based on the ratings given to the product by similar users. Currently several techniques exist for collaborative filtering, such as Nearest Neighbor methods, Probabilistic Graphical methods, and Matrix Factorization Methods. However a limitation of aforementioned methods, lies in recommendation of products that exist at the long tail of a product spectrum, where frequency of purchase is low. Due to low frequency of purchase, historical transaction data in the long tail product spectrum is highly sparse, thereby making accurate recommendations, difficult.

Certain machine learning techniques, such as Bayesian Probabilistic Matrix Factorization, and Variational Bayesian Matrix Factorization, attempt to make accurate recommendations of products lying in the long tail product spectrum. However it is usually difficult to scale the aforesaid methods to realistic commercial scenarios, where a number of users and products lie in range of a million. Further, a memory requirement of a serial processor required for executing the Bayesian Probabilistic matrix factorization method on a dataset of 1.5 GB, is 35 GB random access memory (RAM). Further, time taken for executing the Bayesian Probabilistic matrix factorization method could exceed thirty hours. Hence unless a retailer of the e-commerce business, invests in special hardware accurate recommendations of the long tail product spectrum seems difficult. Hence an alternative system and method is required for addressing scalability of the Variational Bayesian Matrix Factorization method to large data sets of the long tail product spectrum in the e-commerce scenario.

The alternate system and method must parallelize an algorithm implemented for executing the Variational Bayesian Matrix Factorization method on the large data sets on a distributed computing framework. Thus a system and method for performing a distributed probabilistic matrix factorization is proposed.

### SUMMARY

The present invention provides a method and system for distributed probabilistic matrix factorization. In accordance with a disclosed embodiment, the method may include partitioning a sparse matrix into a first set of blocks on a distributed computer cluster, whereby a dimension of each block is MB rows and NB columns. Further, the method shall include initializing a first mean matrix Ū, a first variance matrix Ũ, a first prior variance matrix Ũ^{P}, a second mean matrix V̅, a second variance matrix \tilde{V}, and a second prior variance matrix \tilde{V}^{P} by a set of values from a probability distribution function. The Ū, the Ũ, and the Ũ^{P}, can be partitioned into a second set of blocks on the distributed computer cluster whereby a dimension of each block is the MB rows and K columns. The V̅, the \tilde{V}, and the \tilde{V}^{P} can be partitioned into a third set of blocks on the distributed computer cluster whereby a dimension of each block is the NB rows and the K columns. The Ū, the Ũ, the Ũ^{P}, the \tilde{V}, the \tilde{V}, and the \tilde{V}^{P} can be updated iteratively until a cost function of the sparse matrix converges, whereby each iteration comprises of a plurality of MapReduce steps.

In an additional embodiment, a system for distributed probabilistic matrix factorization is disclosed. The system comprises an initializing component configured to initialize a plurality of matrices by a set of values from a probability distribution function, whereby the plurality of matrices include a first mean matrix Ū, a first variance matrix Ũ and a first prior variance matrix Ũ^{P}, a second mean matrix \tilde{V}, a second variance matrix \tilde{V}, and a second prior variance matrix \tilde{V}^{P}. Further a partitioning component is configured to partition a sparse matrix into a first set of blocks on a distributed computer cluster, whereby a dimension of each block is MB rows and NB columns; and partition the plurality of matrices into a second set of blocks and a third set of blocks on the distributed computer cluster. The system further includes an updating component configured to update the plurality of matrices, iteratively until a cost function of the sparse matrix converges, whereby each iteration comprises of a plurality of MapReduce steps.

These and other features, aspects, and advantages of the present invention will be better understood with reference to the following description and claims.

### BRIEF DESCRIPTION OF THE DRAWINGS

FIG. 1 is a flowchart illustrating an embodiment of a method for distributed probabilistic matrix factorization.

FIGS. 2A, 2B and 2C are flowcharts illustrating a preferred embodiment of a method for distributed probabilistic matrix factorization.

FIG. 3 shows an exemplary system for distributed probabilistic matrix factorization.

FIG. 4 illustrates a generalized example of a computing environment 400.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

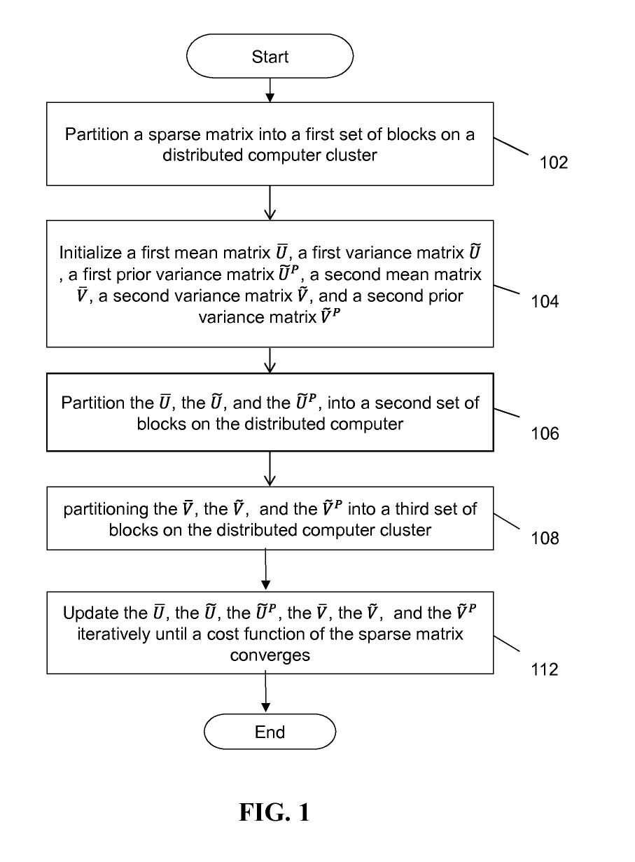

FIG. 1 illustrates a computer-implemented system 100 in accordance with an embodiment of the invention. The system 100 includes a matrix component 102, that represents the sparse matrix X. The matrix X, is distributed across a plurality of machines of a distributed computer cluster 104. The distributed computer cluster 104, can be a typical Hadoop framework. However, the Hadoop framework is not to be construed as limiting in any way, as the architecture maybe deployed on other suitable frameworks.

In order to perform a factorization of the sparse matrix X, the matrix X is partitioned such that parallelism and data locality is maximized.

Disclosed embodiments provide computer-implemented methods, systems, and computer-program products for distributed probabilistic matrix factorization. More specifically the methods, and systems disclosed implement a Variational Bayesian Probabilistic Matrix Factorization Method, on a distributed computer cluster such as a Hadoop Cluster by executing a series of Map Reduce operations.

FIG. 1 is a flowchart that illustrates a method performed in distributed probabilistic matrix factorization in accordance with an embodiment of the present invention. A set of observable data, also referred to as transaction data is represented by a sparse matrix X of dimension M rows and N columns. In a particular embodiment the transaction data may include a plurality of commodities purchased by a plurality of customers, and a plurality of ratings given to the plurality of commodities by the plurality of customers. The plurality of commodities may include products or services intended to be procured by a customer. The sparse matrix X maybe approximated as a product of two low rank matrices, U of dimension M rows and K columns and a transpose of matrix V of dimension N rows and K columns, where K represents a latent feature space of a lower dimension.

X≈UV^{T} Equation 1

Alternatively K may represent a set of features on whose basis, the plurality of products may be categorized, or a set of features depicting categories of customers. A category of customers shall include customers of like preference, in an embodiment. As per a Variational Bayesian Matrix Factorization method, a probability distribution of the sparse matrix X, U and V maybe represented by Equation 2, Equation 3 and Equation 4 as follows:

P(X|U,V)=Πᵢ₌₁^{N}Πₖ₌₁^{K}N(xᵢⱼ|Σₖ₌₁^{K}ūᵢₖ v̅ⱼₖ, σₓ) Equation 2

P(U)=Πᵢ₌₁^{M}Πₖ₌₁^{K}N(uᵢₖ|ūᵢₖ,ũᵢₖ) Equation 3

P(V)=Πⱼ₌₁^{N}Πₖ₌₁^{K}N(vⱼₖ| v̅ⱼₖ,\tilde{v}ⱼₖ) Equation 4

In the aforesaid equations, the parameters ūᵢₖ, ũᵢₖ, ũᵢₖ^{p}, v̅ⱼₖ, \tilde{v}ⱼₖ, \tilde{v}ⱼₖ^{p}, and σ^{x} are found by solving following set of iterative equations:

$$\begin{matrix}{\tilde{u}}_{ik} ← {[ \frac{1}{{\tilde{u}}_{ik}^{p}} + {\sum }_{j \vert ( i , j ) ∈ o}^{ } \frac{{\overline{v}}_{jk}^{2} + {\tilde{v}}_{jk}}{{σ}_{x}} ]}^{- 1} & Equation 5 \\ {\tilde{v}}_{jk} ← {[ \frac{1}{{\tilde{v}}_{jk}^{p}} + {\sum }_{i \vert ( i , j ) ∈ o}^{ } \frac{{\overline{u}}_{ik}^{2} + {\tilde{u}}_{ik}}{{σ}_{x}} ]}^{- 1} & Equation 6 \\ {\overline{u}}_{jk} ← {\overline{u}}_{ik} - λ * {( \frac{{d}^{2} {C}_{KL}}{d {\overline{u}}_{ik}^{2}} )}^{- ∝} ( \frac{d {C}_{KL}}{d {\overline{u}}_{ik}} ) & Equation 7 \\ {\overline{v}}_{jk} ← {\overline{v}}_{jk} - λ * {( \frac{{d}^{2} {C}_{KL}}{d {\overline{v}}_{jk}^{2}} )}^{- ∝} ( \frac{d {C}_{KL}}{d {\overline{v}}_{jk}} ) & Equation 8 \\ {\tilde{u}}_{ik}^{p} ← {\tilde{u}}_{ik} + {\overline{u}}_{ik}^{2} & Equation 9 \\ {\tilde{v}}_{jk}^{p} ← {\tilde{v}}_{jk} + {\overline{v}}_{jk}^{2} & Equation 10 \\ {σ}_{x} = \frac{1}{\vert o \vert} {\sum }_{\vert o \vert}^{ } [ \begin{matrix}{( {x}_{ij} - {\sum }_{k = 1}^{K} {\overline{u}}_{ik} {\overline{v}}_{jk} )}^{2} + \\ {\sum }_{k = 1}^{K} ( {\tilde{u}}_{ik} {\overline{v}}_{jk}^{2} + {\overline{u}}_{ik}^{2} {\tilde{v}}_{jk} + {\tilde{u}}_{ik} {\tilde{v}}_{jk} )\end{matrix} & Equation 11\end{matrix}$$

Where in above equations, the equation 1 to the equation 11,

ũᵢₖ^{p}, is an (i,k) element of a first prior variance matrix, Ũ^{P}. The ũᵢₖ^{p} refers to a prior variance of element (i,k) in the U matrix;

ũᵢₖ, is an (i,k) element of a first variance matrix Ũ. The ũᵢₖ, refers to a posterior variance of element (i,k) in the U matrix;

ūᵢₖ, is an (i, k) element of a first mean matrix Ū. The ūᵢₖ refers to a posterior mean of element (i,k) in the U matrix;

\tilde{v}ⱼₖ^{p}, is an (i,k) element of a second prior variance matrix \tilde{V}^{P}. The \tilde{v}ⱼₖ^{p}, refers to a prior variance of element (j,k) in the V matrix;

\tilde{v}ⱼₖ, is an (i,k) element of a second variance matrix \tilde{V}. The \tilde{v}ⱼₖ refers to a posterior variance of element (j,k) in the V matrix;

v̅ⱼₖ, is an (i,k) element of a second mean matrix \tilde{V}. The \tilde{v}ⱼₖ refers to a posterior mean of element (j,k) in the V matrix; and

σₓ, refers to an observation variance in data or the X matrix.

The aforesaid set of equations can be computed iteratively until a cost function C_{KL} of the sparse matrix X, converges to a minimum value. A convergence of the cost function implies the parameters ūᵢₖ, ũᵢₖ, ũᵢₖ^{p}, v̅ⱼₖ, \tilde{v}ⱼₖ, \tilde{v}ⱼₖ^{p}, have reached a fairly accurate approximate of the sparse matrix. Alternatively, elements of the matrices U and V shall represent an accurate approximate of the sparse matrix X, when the cost function converges. Hence computation of the equation 1 to the equation 11 shall terminate when, the cost function converges. The cost function C_{KL} is a cost function due to Kullback-Leibler (KL) divergence. The C_{KL} is a sum of three distinct component costs viz. C_{KL}^{X}, C_{KL}^{U}, C_{KL}^{V}, where;

$$\begin{matrix}{C}_{KL}^{X} = {\sum }_{i , j ∈ o}^{ } [ \begin{matrix}\frac{1}{2} log ( 2 π {σ}_{x} ) + \frac{{( {x}_{i , j} - {\sum }_{k = 1}^{K} {\overline{u}}_{ik} {\overline{v}}_{jk} )}^{2}}{2 {σ}_{x}} + \\ \frac{{\sum }_{k = 1}^{K} ( {\tilde{u}}_{ik} {\overline{v}}_{jk}^{2} + {\overline{u}}_{ik}^{2} {\tilde{v}}_{jk} + {\tilde{u}}_{ik} {\overline{v}}_{jk} )}{2 {σ}_{x}}\end{matrix} ] & Equation 12 \\ {C}_{KL}^{U} = \frac{1}{2} {\sum }_{i , k}^{ } [ ( \frac{{\overline{u}}_{ik}^{2} + {\tilde{u}}_{ik}}{2 {\tilde{u}}_{ik}^{p}} ) - log \frac{{\tilde{u}}_{ik}}{{\tilde{u}}_{ik}^{p}} - 1 ] & Equation 13 \\ {C}_{KL}^{V} = \frac{1}{2} {\sum }_{j , k}^{ } [ ( \frac{{v}_{jk}^{2} + {\tilde{v}}_{jk}}{2 {\tilde{v}}_{jk}^{p}} ) - log \frac{{\tilde{v}}_{jk}}{{\tilde{v}}_{jk}^{p}} - 1 ] & Equation 14\end{matrix}$$

In order to scale the computation of the aforementioned equations to a large size data, parallelization of the equations is required. As the iterative equations are necessary, parallelization can be done during a computation of each step of iteration. Hence, computation of a plurality of elements of matrices, the Ū, the Ũ, the Ũ^{P}, the V̅, the \tilde{V}, and the \tilde{V}^{P}, the observation variance σₓ, and the cost function C_{KL}, at the each step of the iteration can be parallelized on distributed computer cluster such as that using a Hadoop framework, in order to handle voluminous data. The each iteration can include processing of a sequence of MapReduce steps. At step 102, the sparse matrix can be partitioned into a first set of blocks, by a MapReduce step, on a distributed computer cluster such as a Hadoop Cluster. A dimension of each block includes MB rows and NB columns. Each block maybe indexed by parameters I and J where I can range from 1 to M′=M/MB, and J can range from 1 to N′=N/NB. At step 104, first mean matrix Ū, the first variance matrix Ũ, the first prior variance matrix Ũ^{P}, the second mean matrix V̅, the second variance matrix \tilde{V}, and the second prior variance matrix \tilde{V}^{P} are initialized by a set of values from a probability distribution function. Further at step 106, the Ū, the Ũ, and the Ũ^{P} are partitioned into a second set of blocks by a Mapreduce step, where a dimension of each block can be MB rows and K columns. Typically the each block of this matrix shall have a width of the K columns, implying each row shall exist within a single block. An index I′ can represent the each partitioned block of the Ū, the Ũ, and the Ũ^{P}, and and index i_{B} can index a row within the each block. Similarly at step 108, the V̅, the \tilde{V}, and the \tilde{V}^{P} can be partitioned into a third set of blocks, where a dimension of each block can be NB rows and K columns. An index J′ can represent each partitioned block of the V̅, the \tilde{V}, and the \tilde{V}^{P}, and an index j_{B} shall represent a row within the each block. A height of the each block of the Ū, the Ũ, and the Ũ^{P} shall be MB and a height of the each block of the V̅, the \tilde{V}, and the \tilde{V}^{P} shall be NB. The MB and the NB can be chosen according to values of the M, the N and a configuration of the Hadoop cluster, such that a balance maybe obtained with respect to a distribution of data and network latency. Partitioning of the sparse matrix X can be illustrated as follows:

$$\begin{matrix}X = [ \begin{matrix}{x}_{11} & … & … & … & {x}_{1 N} \\ ⋮ & ⋮ & & & ⋮ \\ ⋮ & & {x}_{ij} & & ⋮ \\ ⋮ & & & ⋮ & ⋮ \\ {x}_{M 1} & … & … & … & {x}_{MN}\end{matrix} ] \\ = [ \begin{matrix}{X}_{11}^{B} & … & {X}_{1 \tilde{N}}^{B} \\ ⋮ & {X}_{IJ}^{B} & ⋮ \\ {X}_{\tilde{M} 1}^{B} & … & {X}_{\tilde{M} \tilde{N}}^{B}\end{matrix} ]\end{matrix}$$

Further portioning of U matrices viz. the Ū, the Ũ, and the Ũ^{P}, and V matrices viz. the V̅, the \tilde{V}, and the \tilde{V}′ can be illustrated as follows:

$$\begin{matrix}U = [ \begin{matrix}{u}_{11} & … & {u}_{1 K} \\ ⋮ & & ⋮ \\ ⋮ & & ⋮ \\ ⋮ & & ⋮ \\ {u}_{M 1} & … & {u}_{MK}\end{matrix} ] \\ = [ \begin{matrix}{U}_{1}^{B} \\ ⋮ \\ {U}_{I}^{B} \\ ⋮ \\ {U}_{\tilde{M}}^{B}\end{matrix} ]\end{matrix}$$

$$\begin{matrix}V = [ \begin{matrix}{v}_{11} & … & {v}_{1 K} \\ ⋮ & & ⋮ \\ ⋮ & & ⋮ \\ ⋮ & & ⋮ \\ {v}_{N 1} & … & {u}_{NK}\end{matrix} ] \\ = [ \begin{matrix}{V}_{1}^{B} \\ ⋮ \\ {V}_{J}^{B} \\ ⋮ \\ {V}_{\tilde{N}}^{B}\end{matrix} ]\end{matrix}$$

At step 112, the U matrices and the V matrices so partitioned are updated iteratively by executing equation 5 to equation 11 on the MapReduce framework, until the cost function as illustrated in Equation 12, Equation 13 and Equation 14, converges to a minimum value.

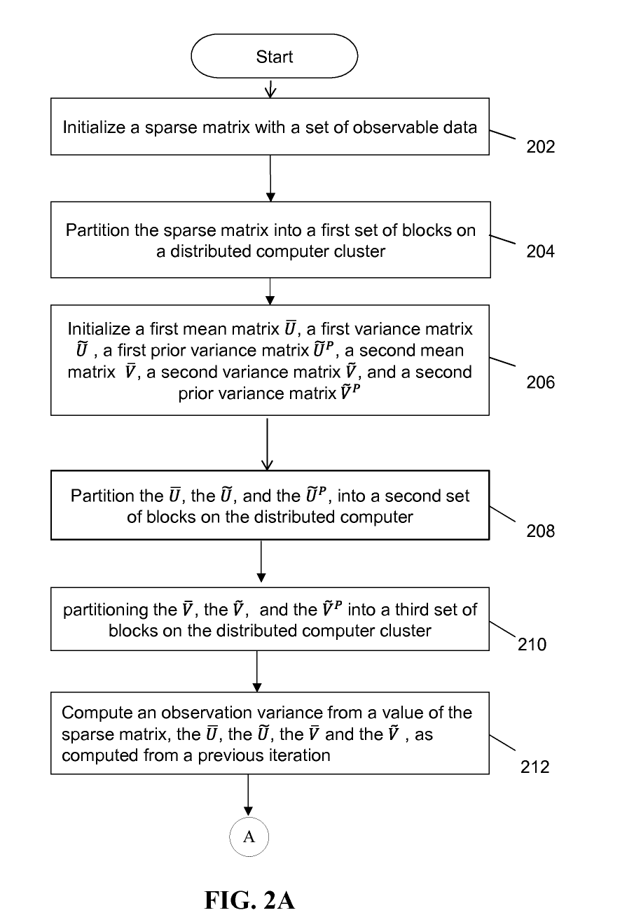

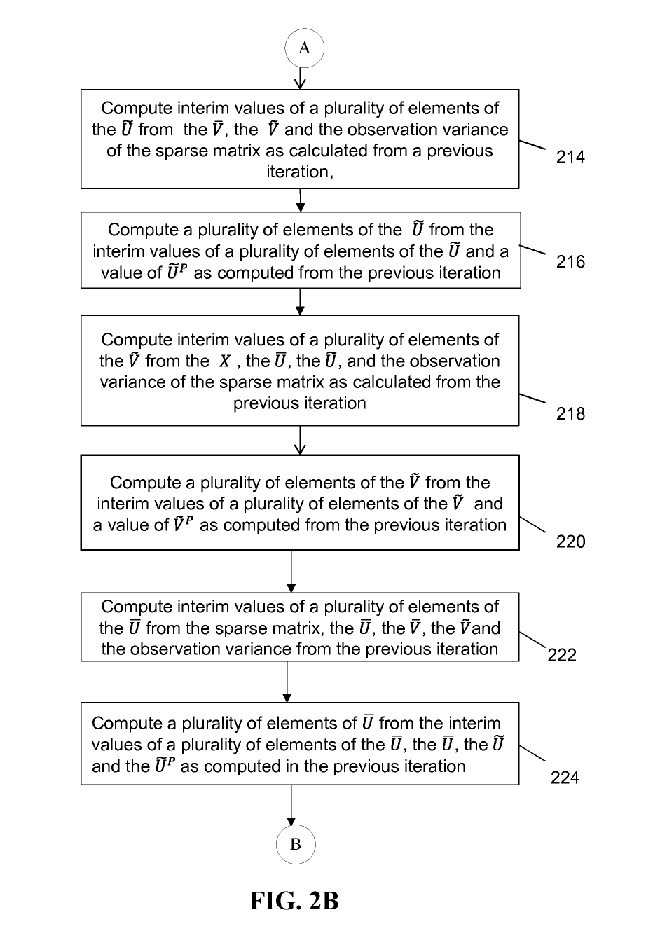

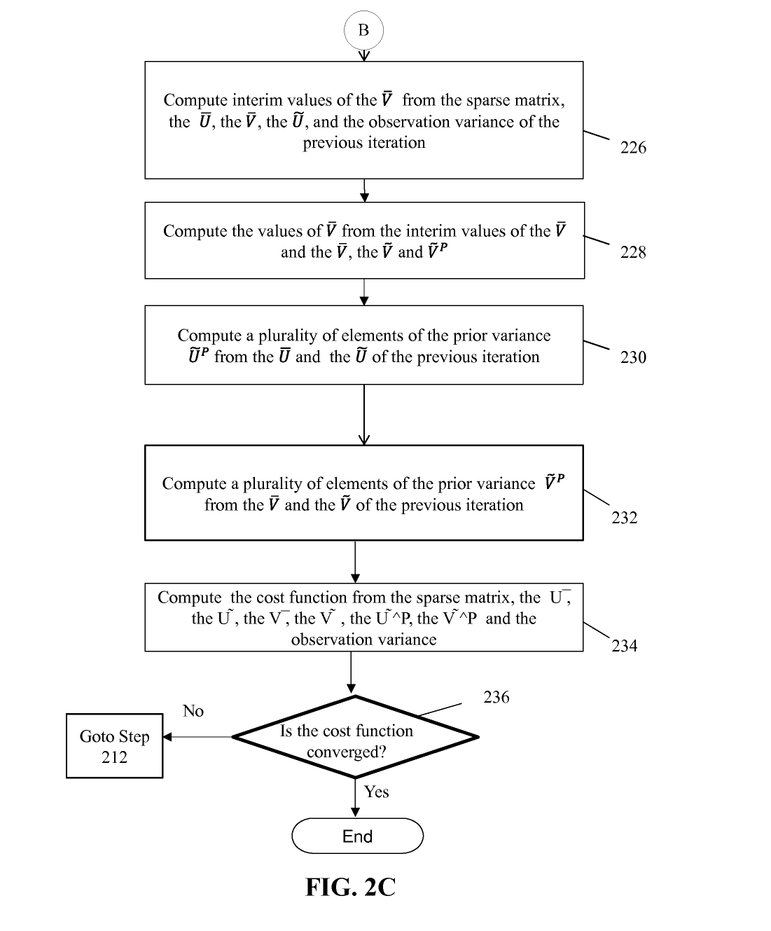

FIGS. 2A, 2B and 2C illustrate an alternate embodiment of a method of practicing the present invention. At step 202, a sparse matrix X can be initialized with observable data. The sparse matrix X, of dimension M rows and N columns, maybe partitioned into a first set of blocks on a distributed computer cluster, such as a Hadoop cluster, where a dimension of each block can be MB rows and NB columns. A MapReduce operation is usually executed for the said partitioning. An element Xij of the sparse matrix, can be taken as an input from an input file. A value of MB, NB, M and N can be taken as an input from a global cache. Each block of the sparse matrix can be indexed by parameters I, and J, where I is equal to (i/MB+1), where i represents an iₜₕ row of the sparse matrix, and J is equal to (j/NB+1), where j represents the jₜₕ columns of the sparse matrix. Further, each row of the each block of the sparse matrix can be indexed by parameter i_{B} and j_{B}, such that i_{B} is equal to (i−(I−1)*MB) and j_{B} equal to (j−(J−1)*NB). For the each block, post the MapReduce operation a key:value pair shall be outputted, such that the key is a three element array, whose first element is a symbol representing the sparse matrix, a second element and a third element is a value of the parameters I and J respectively. Further the value is a three element array, where a first element is a value of the i_{B}, a second element is a value of the j_{B}, and a third element is the element Xᵢⱼ. Similarly at step 208 the U matrices viz. the Ū, the Ũ, and the Ũ^{P} can be partitioned, by a MapReduce operation. A row of one of the U matrices can be represented by an element vector, \vec{u}ᵢ, where i, represents a corresponding iₜₕ row of the one of the U matrices. The \vec{u}ᵢ can be taken as an input from an input file. Further, MB and M′ can be taken as an input from the global cache, where M′=M/MB. Each block of the U matrices can be represented by the parameter I, where I is equal to (1+i/MB) and each row of the each block maybe represented by the parameter i_{B}, where i_{B} is equal to (i−(I−1)*MB). A key:value pair shall be outputted for each of the U matrices. The key is a two element array, where a first element is a symbol representing the U matrix, and a second element is a value of the parameter I, and the value is a two element array, with a first element equal to the parameter i_{B}, and a second element is the element vector \vec{u}ᵢ. Similarly at step 210, the V̅, the \tilde{V}, and the \tilde{V}^{P} matrices shall be partitioned into a third set of blocks, A row of one of the V matrices can be represented by an element vector, \vec{v}ⱼ, where j, represents a corresponding jₜₕ row of the one of the V matrices. The \vec{v}ⱼ can be taken as an input from an input file. Further, NB and N′ can be taken as an input from the global cache, where N′=N/NB. Each block of the V matrices can be represented by the parameter J, where J is equal to (1+j/NB) and each row of the each block maybe represented by the parameter j_{B}, where the j_{B} is equal to (j−(J−1)*NB). A key:value pair shall be outputted for each of the U matrices. The key can be a two element array, with a first element representing the matrix V, and a second element equal to the parameter J. The value is a two element array, with a first element equal to the parameter j_{B}, and a second element equal to the element vector \vec{v}ⱼ. The element vector \vec{u}ᵢ, and the element vector \vec{v}ⱼ of the U matrices and the V matrices respectively can be updated iteratively through steps 212 to 234 until a cost function viz. C_{KL} converges.

At step 212, an observation variance viz. σₓ, maybe calculated as per the Equation 11, where the sparse matrix, and a plurality of elements of the Ū, the Ũ, the Ũ^{P} the V̅, the \tilde{V}, and the \tilde{V}^{P} as computed in a previous iteration are taken as inputs to the Equation 11. The U and V matrices can be updated by executing Equations 5 and Equations 11, via MapReduce operations. The Equation 5 for updating the U matrices, maybe rewritten as follows:

$$\begin{matrix}{\vec{\tilde{u}}}_{i} = {[ {( {\vec{\tilde{u}}}_{i}^{p} )}^{- 1} + {\vec{\tilde{u}}}_{i}^{*} ]}^{- 1} & Equation 15 \\ {\vec{\tilde{u}}}_{i}^{*} = {\sum }_{J}^{ } {\vec{\tilde{u}}}_{i}^{J} & Equation 16 \\ {\vec{\tilde{u}}}_{i}^{J} = {\sum }_{j \vert j ∈ J , O}^{ } \frac{{\vec{\overline{v}}}_{j}^{2} + {\vec{\tilde{v}}}_{j}}{{σ}_{x}} & Equation 17\end{matrix}$$

where {tilde over (\vec{u}*ᵢ, can be referred to as interim values of a plurality of elements of the Ũ. Further {tilde over (\vec{u}ᵢ^{J}, referred to in the Equation 17, shall be computed over a set of elements of the V̅ viz. \vec{v}ⱼ, such that the computation is over a single J block. At step 216, the plurality of elements of the Ũ, can be calculated from the interim values of the plurality of elements of the Ũ as computed in the step 214, and a value of the Ũ^{P} of a previous iteration, as per the Equation 15. Computations at the step 214, and the step 216 can be done by a first sequence of MapReduce steps, where a first map reduce step of the said sequence, shall compute {tilde over (\vec{u}ᵢ^{J}, as illustrated in the Equation 17. A key:value pair emitted in a map step of the first mapreduce shall be a set of arrays, where the key is a two element array, with a first element representing the matrix Ũ, and the second element is i, where the i=((I−1)*MB), and the value is the element vector {tilde over (\vec{u}ᵢ^{J}. The first reduce step, shall further compute the interim value {tilde over (\vec{u}*ᵢ, by summating the emitted value in the first map step viz. {tilde over (\vec{u}*ᵢ=sum(Value). A key:value pair emitted in the first reduce step shall be of the form Ũ:I, and ({tilde over (\vec{u}*ᵢ), respectively where the key is a two element array. In the second map reduce step, the {tilde over (\vec{u}*ᵢ, as computed in the first reduce step, and the Ũ^{p} from a previous iteration, shall be summated. A key:value pair emitted in the second map step shall be a two element array of a form Ũ:I and

$$( {i}_{B} , \frac{1}{sum} )$$

respectively.

At step 218 and 220, a second sequence of MapReduce steps, similar to the first sequence of MapReduce steps shall be processed for computation of a plurality of elements of the second variance \tilde{V}.

At step 222, and step 224, update equations for computation of a plurality of elements of Ū, can be processed by executing a third sequence of MapReduce steps as per the Equation 7,

$$\begin{matrix}{\overline{u}}_{ik} ← {\overline{u}}_{ik} - λ * {( \frac{{d}^{2} {C}_{KL}}{d {\overline{u}}_{ik}^{2}} )}^{- ∝} ( \frac{d {C}_{KL}}{d {\overline{u}}_{ik}} ) \\ Where , & Equation 7 \\ \frac{d {C}_{KL}}{d {\overline{u}}_{ik}} = {\sum }_{j = O}^{ } \frac{1}{{σ}_{x}} [ \begin{matrix}( {x}_{ij} - {\sum }_{l = 1}^{K} {\overline{u}}_{il} {\overline{v}}_{jl} ) {\overline{v}}_{jk} - \\ {\overline{u}}_{ik} {\tilde{v}}_{jk}\end{matrix} ] - ( \frac{{\overline{u}}_{ik}}{{\tilde{u}}_{ik}^{p}} ) & Equation 8\end{matrix}$$

And a formulae for a second derivative of C_{KL} is;

$$\frac{{d}^{2} {C}_{KL}}{d {\overline{u}}_{ik}^{2}} = \frac{1}{{\tilde{u}}_{ik}} \qquad Equation 19$$

The Equation 7, maybe rewritten as,

$${\vec{\overline{u}}}_{i} = {\vec{\overline{u}}}_{i} + {λ ( {\vec{\tilde{u}}}_{i} )}^{α} ( \frac{{\vec{\overline{u}}}_{i}}{{\vec{\tilde{u}}}_{i}^{p}} ) + {\vec{\overline{u}}}_{i}^{*} \\ Where , \\ {\vec{\overline{u}}}_{i}^{*} = {\sum }_{J}^{ } {\vec{\overline{u}}}_{i}^{J} \\ Where , \\ {\vec{\overline{u}}}_{i}^{J} = {\sum }_{j \vert j ∈ J , O}^{ } - {λ ( {\vec{\tilde{u}}}_{i} )}^{α} ( \frac{( {x}_{ij} - {\vec{\overline{u}}}_{i} \cdot {\vec{\overline{v}}}_{j}^{T} ) {\vec{\overline{v}}}_{j} - {\vec{\overline{u}}}_{i} ⊗ {\vec{\tilde{v}}}_{j}}{{σ}_{x}} ) \qquad Equation 21$$

Where, {tilde over (\vec{u}ⱼ [symbol] {tilde over (\vec{v}ⱼ indicates element wise multiplication of two vectors. In a first mapreduce step of the third sequence of mapreduce steps for computation, of Ū, the {tilde over (\vec{u}ᵢ^{J} shall be computed from the Equation 21, and a key:value pair, where the key is a two element array of the form Ū:i, where the first element represents the matrix Ū and the second element represents the parameter i. The value is the element vector ({tilde over (\vec{u}_{hu J}), shall be emitted. In the reduce step, the value as computed in the first map step shall be summated, to compute {tilde over (\vec{u}ᵢ^{B}, where the {tilde over (\vec{u}*ᵢ,=sum(Value). Further, a (key, value) pair shall be emitted in the first reduce step. The key shall be in a form of a two element array, where a first element of the key represents the matrix Ū and the second element includes the parameter i. The key includes a value of the element vector ({tilde over (\vec{u}*ᵢ). In the second map reduce step, a sum value of

$${\vec{\overline{u}}}_{i} + {λ ( {\vec{\tilde{u}}}_{i} )}^{α} ( \frac{{\vec{\overline{u}}}_{i}}{{\vec{\tilde{u}}}_{i}^{p}} ) + {\vec{\overline{u}}}_{i}^{*}$$

shall be computed, and a key:value shall be emitted. The key shall include a two element vector, where the first element represents the matrix Ū and the second element represents the parameter I. The value represents a two element vector, where the first element represents the parameter (i_{B})and the second element includes a value of the sum. At step 226, and step 228 a fourth sequence of map reduce operations shall be performed, for computation of the V̅. The fourth sequence of map reduce operations shall be similar to the third sequence of map reduce steps. Further at step 230, a plurality of elements of the first prior variance, Ũ^{p} from the Ū and the Ũ of the previous iteration. At step 232, a plurality of elements of the prior variance \tilde{V}^{P} shall be computed from the V̅ and the \tilde{V} of the previous iteration. At step 234, the cost function C_{KL}, shall be computed by processing equations 12, 13 and 14 on the MapReduce framework. The cost function C_{KL} maybe rewritten as:

$${C}_{KL}^{X} = {\sum }_{IJ}^{ } {C}^{IJ} \\ Where , \\ {C}^{IJ} = \frac{1}{2 {σ}_{x}} {\sum }_{( i , j ) ∈ ( I , J ) , O}^{ } [ \begin{matrix}{( {x}_{ij} - {\sum }_{k = 1}^{K} {\overline{u}}_{ik} {\overline{v}}_{jk} )}^{2} + \\ {\sum }_{k = 1}^{K} ( {\tilde{u}}_{ik} {\overline{v}}_{jk}^{2} + {\overline{u}}_{ik}^{2} {\tilde{v}}_{jk} + {\tilde{u}}_{ik} {\tilde{v}}_{jk} )\end{matrix} ] . \qquad Equation 22$$

The aforesaid equation shall be processed by a MapReduce step, where, C^{IJ} shall be computed from the Equation 22, and a key:value pair, where the key represents C_{KL}^{X} and the value includes a value of the (C^{IJ}) respectively, shall be emitted. Further, in the reduce step, the key: value pair in the map step, can be taken as inputs, and a C_{KL}^{X} shall be computed, where C_{KL}^{X}=sum(Value). Further, the C_{KL}^{U}, shall be computed by another map reduce step. C^{I} as per the equation 13, shall be computed as follows:

$${C}^{I} = \frac{1}{2} {\sum }_{i , k \vert i ∈ I}^{ } [ ( \frac{{\overline{u}}_{ik}^{2} + {\tilde{u}}_{ik}}{2 {\tilde{u}}_{ik}^{p}} ) - log \frac{{\tilde{u}}_{ik}}{{\tilde{u}}_{ik}^{p}} - 1 ]$$

Further, a key:value pair, where the key represents, the C_{KL}^{U} and the value includes a value of the (C^{I}), shall be emitted. In the reduce step, C_{KL}^{U} can be computed as sum(Value), where value is obtained from the map step. A key:value pair of “C_{KL}^{U}”:C_{KL}^{X} shall then be emitted. Similarly mapreduce steps for computation of “C_{KL}^{V}” maybe executed. At step 236, value of the cost function C_{KL} shall be checked, to know if the cost function has converged. In case the cost function has converged, the update iterations shall be terminated, however, in case the cost function has not converged, the update iterations shall continue to be executed.

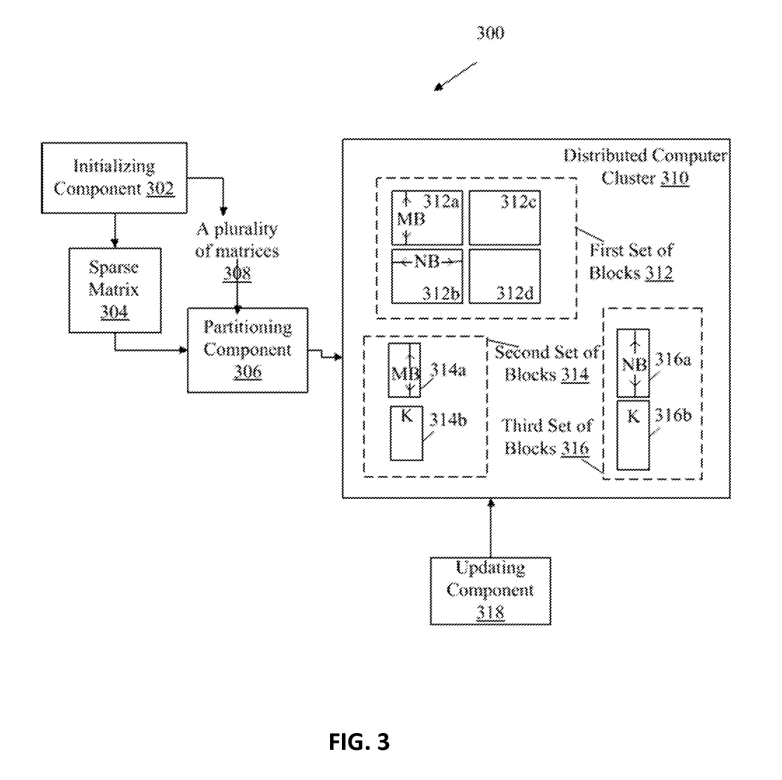

FIG. 3 illustrates an exemplary system 300 in which various embodiments of the invention can be practiced. The system comprises of an Initializing component 302, a sparse matrix 304, a partitioning component 306, a distributed computing cluster 310, and an updating component 318. The sparse matrix 304, can be initialized by a set of observable data. The initializing component 302, shall be configured to initialize a plurality of matrices 308, by a set of values from a probability distribution function, whereby the plurality of matrices 308, shall include a first mean matrix, a first mean matrix Ū, a first variance matrix Ũ and a first prior variance matrix Ũ^{P}, a second mean matrix V̅, a second variance matrix \tilde{V}, and a second prior variance matrix \tilde{V}^{P}. Further, the partitioning component 306, shall be configured to partition the sparse matrix 304, into a first set of blocks 312, on the distributed computing cluster 310, whereby a dimension of each block shall be MB rows and NB columns. The partitioning component 306, maybe further configured to partition the first mean matrix Ū, the first variance matrix Ũ and the first prior variance matrix Ũ^{P}, into a second set of blocks 314 and, the second mean matrix V̅, the second variance matrix \tilde{V}, and the second prior variance matrix \tilde{V}^{P} into a third set of blocks 316. A dimension of each block of the second set of blocks 314, shall be MB rows and K columns, and a dimension of each block of the third set of blocks 316, shall be NB rows and K columns, where K is a number lesser than MB and NB. The updating component 318, shall be configured to update the partitioned plurality of matrices 308, on the distributed computer cluster 310, iteratively, until a cost function of the sparse matrix 304, converges to a minimum value. Each iteration on the distributed computer cluster 310, shall be a sequence of MapReduce steps.

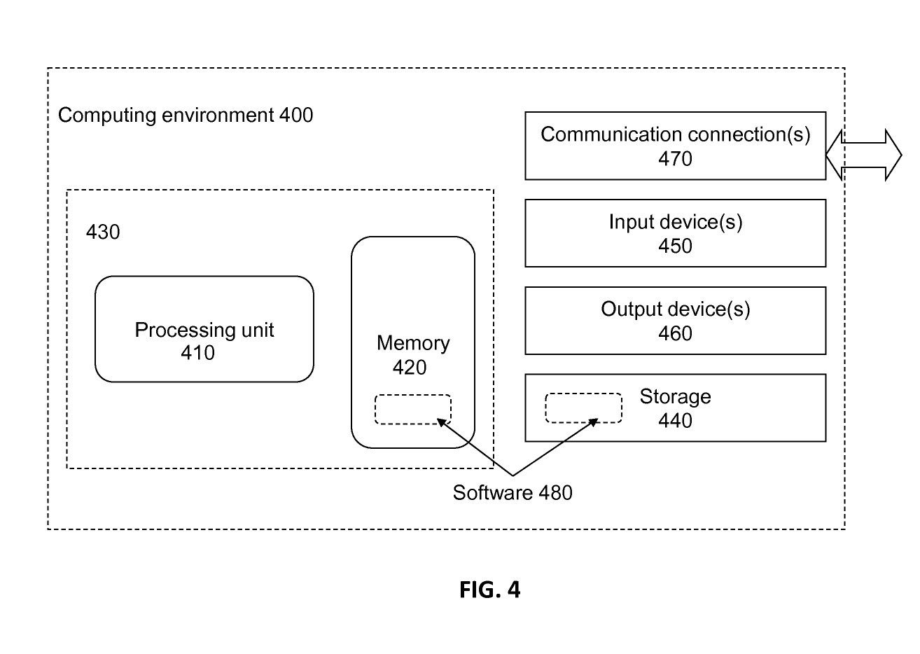

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method for distributed probabilistic matrix factorization, the method comprising:
partitioning a sparse matrix into a first set of blocks on a distributed computer cluster, whereby a dimension of each block is MB rows and NB columns.
initializing a first mean matrix Ū, a first variance matrix Ũ, a first prior variance matrix Ũ^{P}, a second mean matrix V̅, a second variance matrix \tilde{V}, and a second prior variance matrix \tilde{V}^{P} by a set of values from a probability distribution function;
partitioning the Ū, the Ũ, and the Ũ^{P}, into a second set of blocks on the distributed computer cluster whereby a dimension of each block is the MB rows and K columns;
partitioning the V̅, the \tilde{V}, and the \tilde{V}^{P} into a third set of blocks on the distributed computer cluster whereby a dimension of each block is the NB rows and the K columns; and
updating the Ū, the Ũ, the Ũ^{P}, the V̅, the \tilde{V}, and the V̅^{P} iteratively until a cost function of the sparse matrix converges, whereby each iteration comprises of a plurality of MapReduce steps.

2. The method of claim 1, further comprising:
initializing the sparse matrix, with a set of observable data.

3. The method of claim 2, wherein the set of observable data comprises a plurality of commodities purchased by a plurality of customers, and a plurality of ratings of the plurality of commodities, by the plurality of customers.

4. The method of claim 3, wherein a dimension of the sparse matrix includes M rows and N columns, whereby each row represents a set of commodities purchased by a customer.

5. The method of claim 4, wherein an element of the sparse matrix X comprises one of an implicit rating and an explicit rating of a commodity, whereby the implicit rating and the explicit rating is provided by the customer.

6. The method of claim 5, wherein the MB and the NB depends on the M, the N, a configuration of the distributed computing cluster.

7. The method of claim 5, wherein the sparse matrix X is represented as a product of a matrix U and a transpose of a matrix V, whereby a dimension of the matrix U includes the M rows and the K columns, and a dimension of the matrix V includes the N rows and the K columns.

8. The method of claim 7, wherein the cost function of the sparse matrix is a divergence between a probability of the sparse matrix and a probability of the represented product of the matrix U and the matrix V.

9. The method of claim 7, wherein the K represents a number of latent features.

10. The method of claim 7, wherein the Ū, the Ũ, and the Ũ^{P}, represent a mean, variance and a prior variance of a probability distribution of a plurality of elements of the matrix U.

11. The method of claim 10, wherein the V̅, the \tilde{V}, and the \tilde{V}^{P} represent a mean, a variance, and a prior variance of a probability distribution of a plurality of elements of the matrix V.

12. The method of claim 11, wherein the represented product provides a reliable estimate of a set of missing elements of the sparse matrix, when the cost function converges.

13. The method of claim 1, wherein the each iteration includes:
processing a mapreduce step to compute an observation variance from a value of the sparse matrix, the Ū, the Ũ, the \tilde{V} and the V̅, as computed from a previous iteration;
processing a first sequence of two MapReduce steps, wherein the first mapreduce step computes interim values of a plurality of elements of the Ũ from the V̅, the \tilde{V} and the observation variance of the sparse matrix as calculated from a previous iteration, and the second MapReduce step computes a plurality of elements of the Ũ from the interim values of a plurality of elements of the Ũ and a value of Ũ^{P} as computed from the previous iteration;
processing a second sequence of two MapReduce steps, wherein the first MapReduce step computes interim values of a plurality of elements of the \tilde{V} from the X, the Ū, the Ũ, and the observation variance of the sparse matrix as calculated from the previous iteration, and the second MapReduce step computes a plurality of elements of the \tilde{V} from the interim values of a plurality of elements of the \tilde{V} and a value of \tilde{V}^{P} as computed from the previous iteration;
processing a third sequence of two MapReduce steps, wherein the first MapReduce step computes interim values of a plurality of elements of the Ū from the sparse matrix, the Ū, the V̅, the \tilde{V} and the observation variance from the previous iteration, and the second MapReduce step computes a plurality of elements of Ū from the interim values of a plurality of elements of the Ū, the Ū, the Ũ and the Ũ^{P} as computed in the previous iteration;
processing a fourth sequence of two MapReduce steps, wherein the first MapReduce step computes interim values of the V̅ from the sparse matrix, the Ū, the V̅, the Ũ, and the observation variance of the previous iteration, and the second MapReduce step computes the values of V̅ from the interim values of the V̅ and the V̅, the \tilde{V} and \tilde{V}^{P}, as computed in the previous iteration;
processing a mapreduce step to compute a plurality of elements of the prior variance Ũ^{P} from the Ū and the Ũ of the previous iteration;
processing a mapreduce step to compute a plurality of elements of the prior variance \tilde{V}^{P} from the V̅ and the \tilde{V} of the previous iteration; and
processing a mapreduce step to compute the cost function from the sparse matrix, the Ū, the Ũ, the V̅, the \tilde{V}, the Ũ^{P}, the \tilde{V}^{P} and the observation variance.

14. A system for distributed probabilistic matrix factorization, the system comprising:
an initializing component configured to:
initialize a plurality of matrices by a set of values from a probability distribution function, whereby the plurality of matrices include a first mean matrix Ū, a first variance matrix Ũ and a first prior variance matrix Ũ^{P}, a second mean matrix V̅, a second variance matrix \tilde{V}, and a second prior variance matrix \tilde{V}^{P};
a partitioning component configured to:
partition a sparse matrix into a first set of blocks on a distributed computer cluster, whereby a dimension of each block is MB rows and NB columns; and
partition the plurality of matrices into a second set of blocks and a third set of blocks on the distributed computer cluster; and
an updating component configured to:
update the plurality of matrices, iteratively until a cost function of the sparse matrix converges, whereby each iteration comprises of a plurality of MapReduce steps.

15. The system of claim 14, wherein the initializing component is further configured to initialize the sparse matrix by a set of observable data.

16. The system of claim 16, wherein, a dimension of each block of the second set of blocks is the MB rows and K columns, and a dimension of each block of the third set of blocks is the NB rows and the K columns.

17. The system of claim 17, wherein a block of the second set of blocks includes elements of one of the Ū, the Ũ, and the Ũ^{P}.

18. The system of claim 17, wherein a block of the third set of blocks includes elements of one of the V̅, the \tilde{V}, and the \tilde{V}^{P}.

19. The system of claim 15, wherein the set of observable data comprises a plurality of commodities purchased by a plurality of customers, and a plurality of ratings of the plurality of commodities, by the plurality of customers.

20. The system of claim 16, wherein a dimension of the sparse matrix includes M rows and N columns, whereby each row represents a set of commodities purchased by a customer.

21. The system of claim 17, wherein an element of the sparse matrix X comprises one of an implicit rating and an explicit rating of a commodity, whereby the implicit rating and the explicit rating is provided by the customer.

22. The system of claim 18, wherein the MB and the NB depends on the M, the N, a configuration of the distributed computing cluster.

23. The system of claim 18, wherein the sparse matrix X is represented on the distributed computer cluster as a product of a matrix U and a transpose of a matrix V, whereby a dimension of the matrix U includes the M rows and the K columns, and a dimension of the matrix V includes the N rows and the K columns.

24. The system of claim 20, wherein the cost function of the sparse matrix is a divergence between a probability of the sparse matrix and a probability of the represented product of the matrix U and the matrix V.

25. The system of claim 20, wherein the K represents a number of latent features.

26. The system of claim 20, wherein the Ū, the Ũ, and the Ũ^{P}, represent a mean, variance and a prior variance of a probability distribution of a plurality of elements of the matrix U.

27. The system of claim 23, wherein the V̅, the \tilde{V}, and the \tilde{V}^{P} represent a mean, a variance, and a prior variance of a probability distribution of a plurality of elements of the matrix V.

28. The system of claim 24, wherein the represented product provides a reliable estimate of a set of missing elements of the sparse matrix, when the cost function converges.

29. The system of claim 14, wherein the each iteration includes:
processing a mapreduce step to compute an observation variance from a value of the sparse matrix, the Ū, the Ũ, the \tilde{V} and the \tilde{V}, as computed from a previous iteration;
processing a first sequence of two MapReduce steps, wherein the first mapreduce step computes interim values of a plurality of elements of the Ũ from the V̅, the \tilde{V} and the observation variance of the sparse matrix as calculated from a previous iteration, and the second MapReduce step computes a plurality of elements of the Ũ from the interim values of a plurality of elements of the Ũ and a value of Ũ^{P} as computed from the previous iteration;
processing a second sequence of two MapReduce steps, wherein the first MapReduce step computes interim values of a plurality of elements of the \tilde{V} from the X, the Ū, the Ũ, and the observation variance of the sparse matrix as calculated from the previous iteration, and the second MapReduce step computes a plurality of elements of the \tilde{V} from the interim values of a plurality of elements of the \tilde{V} and a value of \tilde{V}^{P} as computed from the previous iteration;
processing a third sequence of two MapReduce steps, wherein the first MapReduce step computes interim values of a plurality of elements of the Ū from the sparse matrix, the Ū, the V̅, the \tilde{V} and the observation variance from the previous iteration, and the second MapReduce step computes a plurality of elements of Ū from the interim values of a plurality of elements of the Ū, the Ū, the Ũ and the Ũ^{P} as computed in the previous iteration;
processing a fourth sequence of two MapReduce steps, wherein the first MapReduce step computes interim values of the V̅ from the sparse matrix, the Ū, the V̅, the Ũ, and the observation variance of the previous iteration, and the second MapReduce step computes the values of V̅ from the interim values of the V̅ and the V̅, the \tilde{V} and \tilde{V}^{P}, as computed in the previous iteration;
processing a mapreduce step to compute a plurality of elements of the prior variance Ũ^{P} from the Ũ and the Ũ of the previous iteration;
processing a mapreduce step to compute a plurality of elements of the prior variance \tilde{V}^{P} from the V̅ and the \tilde{V} of the previous iteration; and
processing a mapreduce step to compute the cost function from the sparse matrix, the Ū, the Ũ, the V̅, the \tilde{V}, the Ũ^{P}, the \tilde{V}^{P} and the observation variance.

30. A computer program product consisting of a plurality of program instructions stored on a non-transitory computer-readable medium that, when executed by a computing device, performs a method for distributed probabilistic matrix factorization, the method comprising:
partitioning a sparse matrix into a first set of blocks on a distributed computer cluster, whereby a dimension of each block is MB rows and NB columns.
initializing a first mean matrix Ū, a first variance matrix Ũ, a first prior variance matrix Ũ^{P}, a second mean matrix V̅, a second variance matrix \tilde{V}, and a second prior variance matrix \tilde{V}^{P} by a set of values from a probability distribution function;
partitioning the Ū, the Ũ, and the Ũ^{P}, into a second set of blocks on the distributed computer cluster whereby a dimension of each block is the MB rows and K columns;
partitioning the V̅, the \tilde{V}, and the \tilde{V}^{P} into a third set of blocks on the distributed computer cluster whereby a dimension of each block is the NB rows and the K columns; and
updating the Ū, the Ũ, the Ũ^{P}, the \tilde{V}, the \tilde{V}, and the \tilde{V}^{P} iteratively until a cost function of the sparse matrix converges, whereby each iteration comprises of a plurality of MapReduce steps.
